(19) United States
(12) Patent Application Publication
(10) Pub. No.: US 2004/0040934 A1
(43) Pub. Date: Mar. 4, 2004

(54) Method of etching a photoresist layer disposed on a semiconductor substrate

(76) Inventor: Chen Chung Tai, Hsinchu (TW)

Correspondence Address: Kenton R. Mullins, Stout, Uxa, Buyan & Mullins, LLP, 4 Venture, Suite 300, Irvine, CA, 92618, US

(21) Appl. No.: 10/236,035

(22) Filed: Sep. 4, 2002

(51) Int. Cl. B44C 1/22; C23F 1/00; C03C 15/00; C03C 25/68

(52) U.S. Cl. 216/83

(57) ABSTRACT

A method of etching a photoresist layer disposed on a substrate includes applying a hydrogen-containing reactive solution onto the substrate to react with the photoresist layer, applying deionized water onto the substrate, and applying ozonated deionized water onto the substrate to remove at least a portion of the photoresist layer. The hydrogen-containing reactive solution can be made up of a spike sulfuric acid solution or a spike sulfuric acid and hydrogen peroxide solution.

### BACKGROUND OF THE INVENTION

1. Field of the Invention

The present invention relates generally to semiconductor processing. More specifically, the present invention relates to a method of etching a photoresist layer disposed on a semiconductor substrate.

2. Description of the Related Art

Semiconductor devices are manufactured by the repetitive application of various processes to a semiconductor substrate, i.e., a wafer. These various processes include layering, patterning/etching, doping, and heat treatment. Of particular interest herein is the patterning/etching process, which involves the removal of material from a surface of the semiconductor substrate. More specifically, the patterning/etching process involves applying a photoresist layer in a particular pattern to the surface of the semiconductor substrate and then selectively etching or removing material from the surface of the semiconductor substrate. The portions of the semiconductor substrate that are covered by the photoresist layer are protected from the etching process, while the portions of the semiconductor substrate that are not covered by the photoresist layer are etched, to some degree, depending on the type and duration of the etching process. Consequently, the unprotected material in the particular pattern is removed from the semiconductor substrate.

Two etching processes employed are commonly referred to as a wet etching process and a dry etching process. The wet etching process involves applying a chemical etchant, that reacts with the unprotected material, to the surface of the semiconductor substrate. As a result, soluble products are formed that include the unprotected material and are carried away by a solvent. The dry etching process involves applying gas molecules and/or ions to the surface of the semiconductor substrate so that the unprotected material is removed either chemically by reacting with the applied material, or physically by bombarding the surface of the semiconductor substrate. The dry etching process is sometimes referred to as a plasma etching process.

After the etching process is complete, the photoresist layer, which remains on the surface of the semiconductor substrate, is conventionally removed by an ashing process. One conventional ashing process injects a gas such as oxygen, which reacts with the chemical etchant or material, onto the semiconductor substrate to remove the photoresist layer. Next, an organic or inorganic solution is applied over the photoresist layer to damage the structure of the photoresist layer to completely remove the remaining photoresist layer. The conventional ashing process is generally used over the wet etching process because the underlying conductive lines are not altered, and it can be more effective in the removal of the photoresist layer. However, one drawback of the ashing process is that it can generate more defects during the dry plasma treatment process. Thus, the subsequence wet etching process may not be able to remove those defects.

The photoresist layer may also be removed by applying ozonated deionized (DI) water to the photoresist layer for the environmental protection concern. This can result in an etching rate with a post-etch or low-dose-implant deep ultraviolet (DUV) type photoresist of about 400 Angstroms (Å)/minute to about 600 Å/minute in a spray spin processor. Generally speaking, this application of ozonated DI water to the photoresist layer can result in an etching rate that is relatively low as compared to the inorganic solution treatment for current manufacturing processes.

Accordingly, a need exists for a method of increasing the etching rate of the photoresist layer of the semiconductor substrate.

### SUMMARY OF THE INVENTION

The present invention addresses this need by providing a method of etching a photoresist layer, including applying a hydrogen-containing reactive solution on the photoresist layer to react with the photoresist layer, applying deionized water on the substrate, and applying ozonated deionized water on the substrate to remove at least a portion of the photoresist layer. The hydrogen-containing reactive solution can, while including hydrogen, include one or more of the following elements or compounds: oxygen, hydrogen oxide, hydrogen peroxide, sulfur, sulfate, sulfur dioxide, sulfur trioxide, and sulfuric acid. In accordance with an aspect of the present invention, manufacturing processes implementing photoresist removal can be more cost effective, whereby, for example, entire wet strip processes of post-etch or low-dose implantation photoresist can be performed without ashing and without the associated lower throughputs.

In accordance with another aspect of the present invention, an etch process includes providing a photoresist material on a substrate, introducing sulfuric acid into a chamber to react with the photoresist material, and exposing the photoresist material to ozonated deionized water to remove the photoresist material. The sulfuric acid can be introduced or sprayed into the chamber for a time period of from about 10 seconds to about 60 seconds. The ozonated deionized water can comprise at least about 60 parts per million of ozone.

According to another aspect of the present invention, a method of etching a photoresist layer of a substrate includes spraying the substrate with a hydrogen-containing reactive solution for a time period of about 10 seconds to about 60 seconds and spraying the substrate with deionized water. The method can also include spraying the substrate with or supplying into the chamber ozonated deionized water at a temperature of about 25 degrees C. and spraying the substrate with or supplying into the chamber heated deionized water at a temperature of about 80 degrees C. to about 95 degrees C.

Any feature or combination of features described herein are included within the scope of the present invention provided that the features included in any such combination are not mutually inconsistent as will be apparent from the context, this specification, and the knowledge of one of skill in the art. For purposes of summarizing the present invention, certain aspects, advantages and novel features of the present invention have been described herein. Of course, it is to be understood that not necessarily all such aspects, advantages or features will be embodied in any particular embodiment of the present invention. Additional advantages and aspects of the present invention are apparent in the following detailed description and claims.

### BRIEF DESCRIPTION OF THE DRAWINGS

FIG. 1 is a side-elevational view of a processing device according to one embodiment of the present invention; and

FIG. 2 is a simplified flow diagram of a method of etching a photoresist layer disposed on a semiconductor substrate according to one embodiment of the present invention.

### DETAILED DESCRIPTION OF THE PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the manufacture of via structures. The present invention may be practiced in conjunction with various integrated circuit fabrication techniques that are conventionally used in the art, and only so much of the commonly practiced process steps are included herein as are necessary to provide an understanding of the present invention. The present invention has applicability in the field of semiconductor devices and processes in general. For illustrative purposes, however, the following description pertains to a processing device and a method of etching a photoresist layer disposed on a semiconductor substrate.

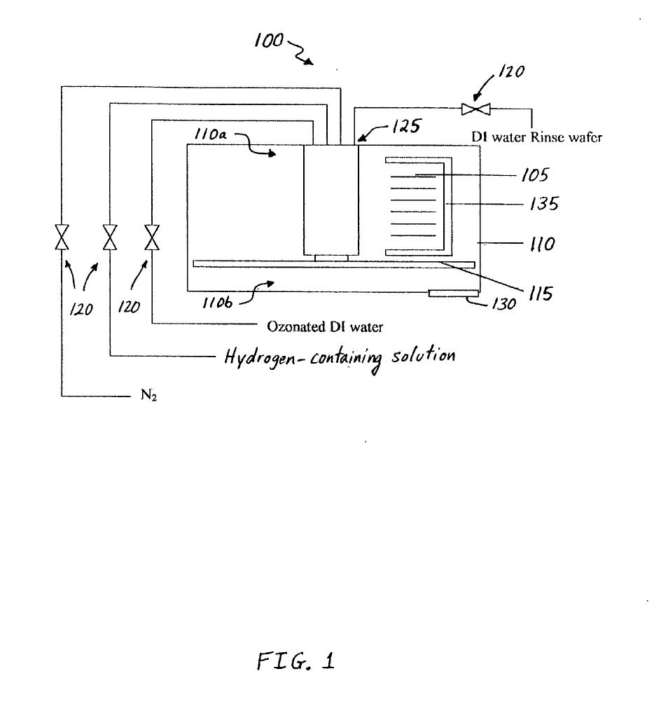

Referring more particularly to the drawings, FIG. 1 is a schematic, side-elevational view of a processing device 100, which can be used for the rapid and uniform chemical and/or physical treatment of a semiconductor substrate 105 in accordance with an embodiment of the present invention. The processing device 100 can also be referred to as a spray processor. In the illustrated embodiment, the processing device is an acid spray processor manufactured by FSI International. The processing device 100 includes a fluid-tight treatment chamber 110 having a top portion 10a and a bottom portion 10b, a turntable 115 located at the bottom portion 110b of the chamber 110 for rotating the substrate 105, and a spraying mechanism 120 located at the top portion 110a of the chamber 110 for applying a fluid, e.g., a liquid or a gas, to at least one surface of the substrate 105. The turntable 115 can be rotated to provide for more controlled depositions and/or uniform treatments of the fluid on the surface of the substrate 105. In addition, the turntable 115 can be used to spin dry the substrate 105. The spraying mechanism 120 has a plurality of nozzles 125 where each nozzle can be connected to a tank (not shown) and is configured to spray a different fluid, such as a nitrogen gas, hydrogen-containing reactive solution, ozonated DI water, and DI water, into the chamber 110 and onto the surface of the substrate 105. Hence, different fluids may be applied to the substrate 105 simultaneously or in succession.

In one embodiment, the processing device 100 includes an outlet 130, which is connected to a suction device (not shown) for removing the applied fluid from the chamber 110. The processing device 100 can also include a cassette 135 for holding a plurality of substrates 105 in a stacked relationship in the chamber 110, an elevator (not shown) for raising and lowering the cassette 135, and a robotic arm assembly (not shown) for moving the substrate 105 from the cassette 135 to the turntable 115. In addition, the processing device 100 can include a carrier (not shown) for holding the substrate 105 on the turntable 115. The processing device 100 and other processing devices known in the art can be used to practice the method of the present invention.

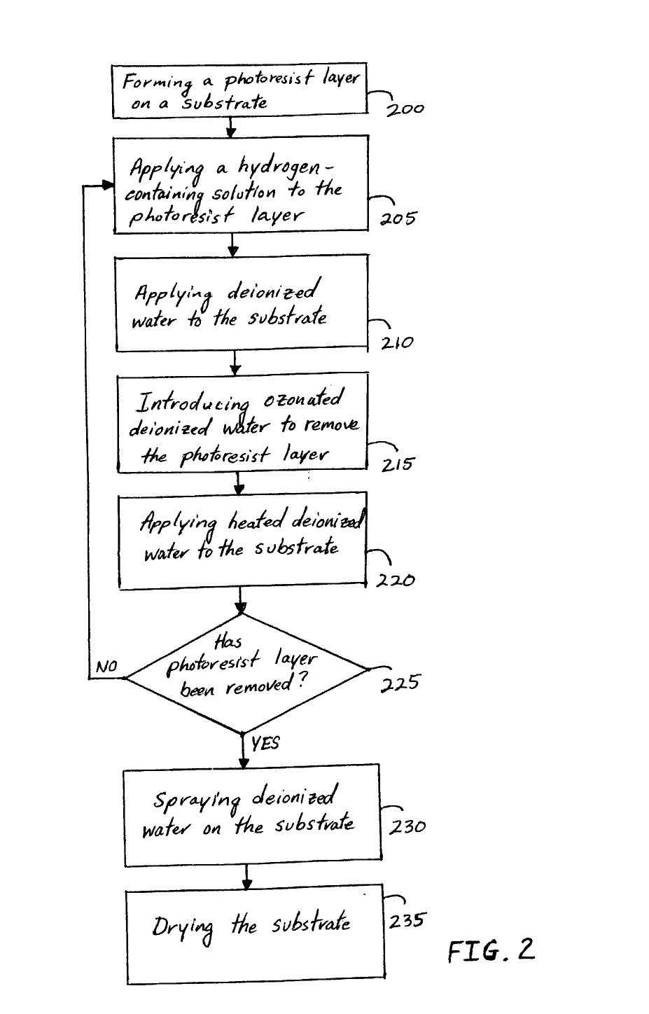

Referring to both FIGS. 1 and 2, a method of etching a photoresist layer disposed on the substrate 105 can begin when the substrate 105 is disposed in the chamber 110 with a photoresist layer having been previoulsy deposited on the surface thereof. The photoresist layer can be formed in the shape of a desired pattern on the surface of the substrate 105 (step 200) using well-known processes. The photoresist layer can have a thickness, for example, in the range of about 5,000 Å to about 15,000 Å. The photoresist layer can be any type of photoresist or a combination of photoresists, such as positive, negative, or deep ultraviolet (DUV). Preferably, the photoresist has a carbon chain structure. After the photoresist layer is deposited the substrate 105 is etched using either a wet etching process or a dry etching process, and then the photoresist layer is removed using the following process.

At step 205, a hydrogen-containing reactive solution is introduced into the chamber 110 through one or more of the plurality of nozzles 125 for deposition on the photoresist layer of the substrate 105. The hydrogen-containing reactive solution can be introduced into the chamber 110 at a flow rate of about 600 to about 3000 standard cubic centimeter per minute (sccm).

The hydrogen-containing reactive solution can be applied or sprayed on the surface of the photoresist layer for about 10 seconds to about 60 seconds. While the hydrogen-containing reactive solution is being applied on the photoresist layer, the substrate 105 can be rotated on the turntable 115 to ensure that the photoresist layer is completely and uniformly covered with a coating of the hydrogen-containing reactive solution. Alternatively, the substrate 105 can be rotated after the hydrogen-containing reactive solution is applied to the photoresist layer to uniformly distribute the hydrogen-containing reactive solution over the photoresist layer. An exemplary hydrogen-containing reactive solution, while including hydrogen, comprises a fluid having one or more of the following elements or compounds: oxygen, hydrogen oxide, hydrogen peroxide, sulfur, sulfate, sulfur dioxide, sulfur trioxide, and sulfuric acid. In the illustrated embodiment, the hydrogen-containing reactive solution is spike sulfuric acid, H₂SO₄, solution. In a modified embodiment, the hydrogen-containing reactive solution can comprise, for example, a spike hydrogen peroxide solution. The hydrogen-containing reactive solution can be a spike sulfuric acid and hydrogen peroxide, i.e., spike H₂SO₄/H₂O₂, solution with a volume ratio of sulfuric acid to hydrogen peroxide being in the range of about 2:1 to about 10:1.

The hydrogen-containing reactive solution reacts with and/or changes at least one property of the photoresist layer, making the photoresist layer more reactive with the ozonated DI water in a subsequent spin spray process (step 215, infra). In particular, it is believed that in the illustrated embodiment the hydrogen-containing reactive solution converts a single bond in the carbon chain of the photoresist layer to a double bond. This change in chemical structure may cause the photoresist layer to react more easily and quickly with the ozonated DI water, thus increasing the etching rate of the photoresist layer. After the hydrogen-containing reactive solution is applied, the application of the DI water (step 210) may be delayed for about 30 seconds to allow for the chemical reaction between the hydrogen-containing reactive solution and the photoresist to occur. By reacting the photoresist with the hydrogen-containing reactive solution, the etching rate of the photoresist layer can be increased to between about 1,000 Å/minute and about 1,300 Å/minute in the illustrated embodiment. This can shorten the manufacturing cycle time of the substrate 105, and can also abrogate the need to implement an ashing process, which may have a lower than desired etching rate.

In addition, the hydrogen-containing reactive solution may cause the photoresist layer to be partially or completely etched or peeled off from the wafer. Whether the hydrogen-containing reactive solution etches the photoresist layer may depend on the chemical composition of the hydrogen-containing reactive solution and the amount of time the hydrogen-containing reactive solution remains on the substrate before it is rinsed off in a subsequent step. In one embodiment, the etching rate of the photoresist layer is proportional to the amount of time the hydrogen-containing reactive solution remains on the photoresist layer. In the illustrated embodiment, the hydrogen-containing reactive solution causes the photoresist layer to be partially peeled off from the wafer.

At step 210, one or more of the plurality of nozzles 125 introduce DI water into the chamber 110 to be applied or sprayed on the surface of the substrate 105. The DI water can be introduced at a flow rate of about 1250 to about 8000 sccm for about 120 seconds to thereby resin the substrate 105. In one embodiment, the DI water is left on the surface of the photoresist layer for a period of time following application thereof. In addition, the DI water can be used to rinse or remove the hydrogen-containing reactive solution from the surface of the substrate 105. The temperature of the DI water can be in a range of about 20 degrees Celsius (C) to about 95 degrees C.

Ozonated DI water can then be introduced into the chamber 110, using one or more of the plurality of nozzles 125, to be applied to the photoresist layer to partially or completely remove (e.g., strip) the photoresist layer, at step 215. The ozonated DI water can be introduced at a flow rate of about 3000 sccm for about 120 seconds to about 3000 seconds. The ozonated DI water can comprise between about 60 parts per million (ppm) and about 115 ppm of ozone. In one embodiment, the concentration of dissolved ozone in the DI water is at least about 60 ppm. In the illustrated embodiment, the ozonated DI water is applied at room temperature, which can be for example a temperature of about 25 degrees C.

The rate at which the photoresist layer is removed, i.e., the etching rate, can be increased due to the prior application of the hydrogen-containing reactive solution to the photoresist layer. Specifically, the hydrogen-containing reactive solution can alter the chemical (e.g., bonds) and/or mechanical (e.g., peeling) properties of the photoresist layer so that when the ozonated DI water is applied to the photoresist layer, the ozonated DI water has a greater reaction with the photoresist layer resulting in the photoresist layer being removed at a much faster rate. At step 215 ozone can be de-absorbed from the ozonated DI water and can react with the photoresist layer to facilitate removal of the photoresist layer. In one embodiment, step 210 can be minimized or omitted and the ozonated DI water can be used to rinse the hydrogen-containing reactive solution from the surface of the substrate 105.

At step 220, heated DI water is introduced into the chamber 110, using one or more of the plurality of nozzles 125, to be applied to the surface of the substrate 105 to raise the temperature of the substrate 105. In one embodiment, the substrate 105 is raised to a temperature of about 85 degrees C. In the illustrated embodiment, the heated DI water is introduced (e.g., sprayed) onto the wafer at a temperature of between about 80 degrees C. and about 95 degrees C. at a flow rate of about 3000 sccm for about 1 second to about 3000 seconds. The step of introducing hot DI water (step 220) can be implemented to increase the reaction, and can be performed before, simultaneously with, or after the step of introducing the ozonated DI water (step 215). In the illustrated embodiment, the heated D1 water is introduced before or simultaneously with the step of introducing the ozonated DI water.

The processing device 100 can be used to determine whether the photoresist layer has been sufficiently or completely removed at step 225. This may be accomplished by, for example, reflectometry measurements. If the photoresist layer has not been sufficiently removed, the method beginning at step 205 can be repeated. Preferably, steps 205, 210, 215, and 220 are repeated. One of skill in the art will appreciate that one or more of the steps can be modified, omitted or repeated in modified embodiments while still maintaining the spirit and scope of the present invention. In addition, the order of the steps can be rearranged in modified embodiments while still maintaining the spirit and scope of the present invention. The method of the present invention can be applied to the general removal of a photoresist layer from any of the semiconductor or interconnection layers of the substrate 105. Once the photoresist layer has been completely removed, the method can continue to step 230.

At step 230, one or more of the plurality of nozzles 125 introduce DI water into the chamber 110 to be applied to the surface of the substrate 105. The DI water can be applied to the surface to rinse the substrate 105 and to remove any residual materials remaining from the etching process. The substrate 105 can then be dried at step 235 by, for example, spinning the turntable 115. In an exemplary process, the turntable 115 may be spun for about 480 seconds at about 500 revolutions per minute.

The above-described embodiments have been provided by way of example, and the present invention is not limited to these examples. Multiple variations and modification to the disclosed embodiments will occur, to the extent not mutually exclusive, to those skilled in the art upon consideration of the foregoing description. For example, the hydrogen-containing reactive solution can comprise a variety of elements or compounds while still maintaining the spirit and scope of the present invention. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A method of etching a photoresist layer disposed on a substrate, the method comprising:
applying a hydrogen-containing reactive solution onto the substrate to react with the photoresist layer;
applying deionized water onto the substrate; and
applying ozonated deionized water onto the substrate to loosen or remove at least a portion of the photoresist layer.

2. The method of claim 1, wherein the hydrogen-containing reactive solution comprises, while including hydrogen, at least one of oxygen, hydrogen oxide, hydrogen peroxide, sulfur, sulfate, sulfur dioxide, sulfur trioxide, and sulfuric acid.

3. The method of claim 1, wherein the hydrogen-containing reactive solution is a spike sulfuric acid solution.

4. The method of claim 1, wherein the hydrogen-containing reactive solution is a spike hydrogen peroxide solution.

5. The method of claim 1, wherein the hydrogen-containing reactive solution is a spike sulfuric acid and hydrogen peroxide solution.

6. The method of claim 5, wherein a weight ratio of the sulfuric acid to the hydrogen peroxide is in a range of about 2:1 to about 10:1.

7. The method of claim 1, wherein the hydrogen-containing reactive solution is applied on the photoresist layer for a time period of about 10 seconds to about 60 seconds.

8. The method of claim 1, wherein the ozonated deionized water is applied on the substrate for a time period of about 120 seconds to about 3000 seconds.

9. The method of claim 1, further comprising applying heated deionized water at a temperature of about 80 degrees C. to about 95 degrees C. onto the substrate.

10. A method of etching a photoresist layer disposed on a substrate, the method comprising:
spraying a hydrogen-containing reactive solution on the substrate to react with a first portion of the photoresist layer; and
applying ozonated deionized water on the substrate to remove a second portion of the photoresist layer.

11. The method of claim 10, wherein the second portion includes at least part of the first portion.

12. The method of claim 10, wherein at least part of the first portion is removed before the ozonated deionized water is applied.

13. The method of claim 10, wherein the hydrogen-containing reactive solution is a spike sulfuric acid solution.

14. The method of claim 10, wherein the hydrogen-containing reactive solution comprises sulfuric acid and hydrogen peroxide, and wherein a weight ratio of the sulfuric acid to the hydrogen peroxide is in the range of about 2:1 to about 10:1.

15. The method of claim 10, further comprising spraying heated deionized water at a temperature of from about 80 degrees C. to about 95 degrees C. onto the substrate.

16. An etch process comprising:
providing a photoresist material on a substrate;
introducing a sulfuric-acid containing solution into a chamber to react with the photoresist material; and
exposing the photoresist material with ozonated deionized water to remove the photoresist material.

17. The etch process of claim 16, wherein the introducing of sulfuric acid into the chamber comprises introducing a spike sulfuric acid solution for a time period of about 10 seconds to about 60 seconds.

18. The etch process of claim 16, wherein the ozonated deionized water comprises at least about 60 parts per million of ozone.

19. A method of etching a photoresist layer of a substrate, the method comprising:
(a) providing a substrate with a photoresist layer formed thereon;
(b) spraying the substrate with a hydrogen-containing reactive solution;
(c) performing a first rinse process;
(d) dispensing ozonated deionized water to loosen or remove at least a portion of the photoresist layer; and
(e) repeating (b)-(d) until a predetermined amount of the photoresist layer is removed; and
(f) performing a second rinse process.

20. The method of claim 19, wherein:
the substrate is a wafer;
the hydrogen-containing reactive solution comprises an acid;
the rinse processes of (c) and (f) are performed by spraying the substrate with deionized water; and
the repeating of (b)-(d) is performed until the photoresist layer is substantially completely removed.

21. The method of claim 20, wherein the hydrogen-containing reactive solution comprises sulfuric acid.

22. The method of claim 21, wherein:
the ozonated deionized water is dispensed in a chamber; and
the method further comprises drying the substrate in the chamber.

23. The method of claim 20, wherein the hydrogen-containing reactive solution comprises spike sulfuric acid solution.

24. The method of claim 20, wherein the hydrogen-containing reactive solution comprises spike sulfuric acid and hydrogen peroxide solution, with a weight ratio of the sulfuric acid to the hydrogen peroxide being in the range of about 2:1 to about 10:1.

25. The method of claim 20, wherein (e) is preceded by spraying the substrate with heated deionized water at a temperature of about 80 degrees C. to about 95 degrees C.
